(19) United States
(12) Patent Application Publication
(10) Pub. No.: US 2016/0028717 A1
(43) Pub. Date: Jan. 28, 2016

(54) METHOD AND DEVICE FOR CONTROLLING THE ACCESS TO DIGITAL CONTENT

(71) Applicant: DEUTSCHE TELEKOM AG, Bonn (DE)

(72) Inventors: Andreas Eugen Apeldorn, Ruesselsheim (DE); Mark Mauerwerk, Koenigstein (DE)

(21) Appl. No.: 14/774,737

(22) PCT Filed: Mar. 11, 2014
(86) PCT No.: PCT/EP2014/054676

§ 371 Date: Sep. 11, 2015

(30) Foreign Application Priority Data
Mar. 12, 2013 (DE) 10 2013 102 487.4

(51) Int. Cl. H04L 29/06

(52) U.S. Cl. CPC H04L 63/083; H04L 63/101

(57) ABSTRACT

A method for controlling the access to digital data in a system including a mobile terminal having a network interface, a geographically limited network segment that provides a network solution which ensures that the localization of the mobile terminal takes place and the identification of the network segment can be carried out, a usage server which controls access to the digital data and ensures the compliance with specific rights, includes the steps: obtaining the unique identification of the network segment in which the mobile terminal is located; evaluation of the unique identification on a usage server which controls the access to digital data based on the unique identification by transferring an access list to the application; and display of the digital data on the mobile terminal via the application.

CROSS-REFERENCE TO PRIOR APPLICATIONS

This application is a U.S. National Stage Application under 35 U.S.C. §371 of International Application No. PCT/EP2014/054676 filed on Mar. 11, 2014, and claims benefit to German Patent Application No. DE 10 2013 102 487.4 filed on Mar. 12, 2013. The International Application was published in German on Sep. 18, 2014 as WO 2014/139998 A1 under PCT Article 21(2).

### FIELD

The invention relates to a method for controlling the access to digital data, comprising a mobile terminal having a network interface and a geographically limited network segment.

### BACKGROUND

The principle of the classic, stationary access to digitisable content (generally eBooks, eMagazines, ePapers, music, videos, films, digital vouchers, and others—eContent in the following) is known from a large number of suppliers, such as Apple, Amazon, etc. This approach, however, is not very flexible.

For this reason, developments in the direction of stationary concepts, which allow certain content to be read in certain locations or access to be obtained to certain content or services, have already been pursued.

U520090049057 “METHOD AND DEVICE FOR PROVIDING LOCATION BASED CONTENT DELIVERY” discloses a system relating to location-based access for the identification of users and for the individual provision of information via content.

EP1274264, EP127464: “Location Based Content Delivery” discloses a localisation that is controlled by the terminal, by calling up a table stored in the terminal.

Existing DRM (digital rights management) is linked to individual users or devices. Although so-called location-aware access control systems tie DRM and access control to certain locations/places, at the same time the rights holders themselves are mobile. Directly tying protected content to publicly accessible locations regardless of the current user has neither been described nor implemented previously—the location is fixed, readers may change and in each case may only temporarily (during the visiting period) use the content which the local rights holder provides (metaphor =“virtual reading room”). It emerges from this that the object of the present invention is to provide such a control system that renders it possible to read certain content of a certain environment or renders it possible to access such content.

### SUMMARY

In an embodiment, the present invention provides a method for controlling access to digital data in a network comprising a mobile terminal having a network interface, a geographically limited network segment that provides a network solution which ensures that localization of the mobile terminal takes place in the network segment and an identification of the network segment can be carried out, a usage server which controls access to the digital data and ensures a compliance with specific rights. The method includes the steps: obtaining a unique identification of the network segment in which the mobile terminal is located; evaluating the unique identification on a usage server which controls the access to digital data based on the unique identification by transferring an access list to the application, wherein the usage server issues a token which is transferred to the application once the unique identification has been received, wherein the token specifies which digital data the application has access to and under what conditions; and displaying of the digital data on the mobile terminal via the application.

### BRIEF DESCRIPTION OF THE DRAWINGS

The Figures show possible flow charts for the present invention:

FIG. 1 shows a method with an application on a mobile device which receives a token;

FIG. 2 shows a method in which the flow of information is described with regard to the functions used;

FIG. 3 shows the sequence steps on the application and its user interaction;

FIG. 4 shows a flow chart of the application;

FIG. 5 shows another flow chart of the application.

### DETAILED DESCRIPTION

The invention describes a solution for location-based DRM which allows temporary, location-dependent access to protected electronic multimedia content using mobile devices (generally smartphones, tablets, laptops) regardless of a specific content supplier.

The invention comprises a system and a method for controlling the access to digital data. These digital data may be not only classic music data, video data, games or information data in written form but may also mean content actively created at the location (e.g. blogs or discussion forums) which allow access for only a limited amount of people. The invention relates additionally not only to the calling up but also to the creation of digital content—e.g. reports. Thus the term data is not merely to be limited to downloadable content but may also pertain to dialogue-oriented forums which are not characterised by pure data in static form. Moreover, the invention comprises a mobile terminal having a network interface, which terminal, on a geographically limited network segment, can be uniquely assigned to a holder of rights to the digital data provided in said network segment. These are generally WLAN networks, but other networks such as Bluetooth, GSM networks or LTTE or UMTS networks may also be meant, which have a cell structure and are therefore locally limited. These network segments have a unique identification which is generally provided by a gateway of this network segment. The unique identification of the network segment is used to implement control of the access to the digital data.

The method comprises the following steps:

Obtaining the unique identification of the network segment from the local gateway, in which the mobile terminal is located, by means of an application which displays the digital data;
Forwarding the unique identification to a usage server which controls the access to digital data based on the unique identification by transferring an access authorisation to the application;
Display of the digital data on the mobile terminal via the application in accordance with the contractual conditions of the content that can temporarily be used locally.
Secure deletion of the content after leaving the location or the range of the network segment, but at least after expiry of the temporary read rights.

In a preferred embodiment, the unique identification of the network segment is secured by a signature vis-à-vis the usage server such that misuse of the identification is prevented. Thus the identification of the network segment is provided with a signature which the usage server verifies.

In a preferred embodiment, the usage server issues a token which is passed to the application once the unique identification has been received, the token specifying which data the application has access to, while the application transmits the token on each access to the data, such that a data server which provides the data can check, based on the token, whether or not the data are to be provided. The structure of the token will be described further down. The token is generally a SAML assertion or a comparable technology which enables secure authentication and authorisation. The token is used to specify which network segment gets access to what data. The token for the network segment is therefore put together specifically and maps the identification of the network segment as well as the rights of the rights holder to the data in the local area of the network segment which data may be accessed from the network segment.

Basically, two different scenarios are to be considered. In a preferred embodiment, the application runs as an application (APP) on a mobile terminal. Such an application may be accessed, for example, through known central stores such as Market Store, App Store or Playstore. It is also conceivable that the application is already configured as an integral part of the firmware of a mobile terminal In this case, access takes place through the application to the gateway of the network segment, and the application requests the token from the usage server. The application generally has a secured storage area (SandBox) in which the downloaded data are stored if this is necessary. Of course, data that do not need to be stored locally or that merely need to be obtained by streaming are preferred, with anything which has been played back then being discarded by the device. However, if the data also have to be stored locally, this takes place in a secured area to which only the application has access. The application makes this storage area no longer accessible or deletes it after the network segment is left. Thus the application also monitors entrance to and exit from the network segment. In addition, the application also manages the application for the token and transmission of the token to the servers which provide the data. The application thus represents an interface to the components of the invention. As a result of this, the application obtains the identification of the network segment from the gateway by contacting the network segment.

In an alternative embodiment, the application can also run on a server and the mobile terminal is merely a display unit. In this case, the application runs on a server which the mobile terminal accesses with a browser, the display taking place merely on the mobile terminal but access to the data taking place through the server. Thus it is only display data that are transmitted and not content data. The content data remain on the application server which has the same function as has already been described above.

A (local network segment), also referred to as a virtual room, controls the access, via a mobile device, to certain protected electronic content (eBooks, music, documents) with a limit on location and time, and combines the following properties:

a) A mobile device with standardised network technology (e.g. WiFi) is used to enter the virtual reading room

b) A location-based DRM for electronic content is connected to the network

c) The location-based DRM is independent of the various suppliers for electronic content

d) An application, which communicates with the network and ensures the DRM on the reader, is installed on the mobile device,

The following steps are performed in the process:

1. The network assigns a temporary, local network address to a mobile terminal, this takes place preferably by means of known mechanisms, such as by DHCP in the case of WiFi. The DHCP can also communicate the address of the gateway which takes over the corresponding ID management. In addition, information can be conveyed about the access server, which correspondingly provides the token.

2. The app/application gets an access permit to the content by means of a location-specific token which is only valid for the defined area.

3. Via the application on the mobile device, it is possible at the location of the network segment to access the content according to the contractual arrangements (tying to the DRM of the specific content).

4. On leaving the virtual reading room, the location-specific token including any cached content is deleted from the app, thereby preventing further access to the content

5. Inappropriate use of the content is prevented via safety mechanisms on the local network

6. A mechanism which invalidates the token if certain local information is missing (e.g. MAC address of the gateway) or IP address,

7. The app contains mechanisms which, on request, permit the purchase of personal rights to the content so that it can be picked up and taken. In a further embodiment, it is also possible for the user to pick up and take the content by acquiring it appropriately or providing other declarations or consents.

With the invention, protected eContent can be temporarily activated in locations/local areas with wireless network reception (i.e. WiFi). The owner of a mobile device (particularly smartphones, tablets and notebooks) can access the eContent in full without authentication as soon as—and as long as—he stays in the location. If he leaves the location, the access also expires—unless the user has purchased the content. The digital rights management is bound to the location.

For every user of a mobile device, the idea of provider-independent, location-dependent access to content combines the advantages of online trade (access to content with one's own device) with the advantages of stationary trade (i.e. personal advice, support for the purchase decision by considering and assessing the content). Location-based access to content also offers new

Service concepts (i.e. “electronic reading circles”, access to eContent in libraries, access to videos, music, audiobooks, etc. using one's own device on trains, aeroplanes, etc.)
And new sales concepts (i.e. eKiosks on railway platforms, in hotels, in branches of companies, airports, etc.)
Marketing concepts (i.e. vouchers that are only available within a location)

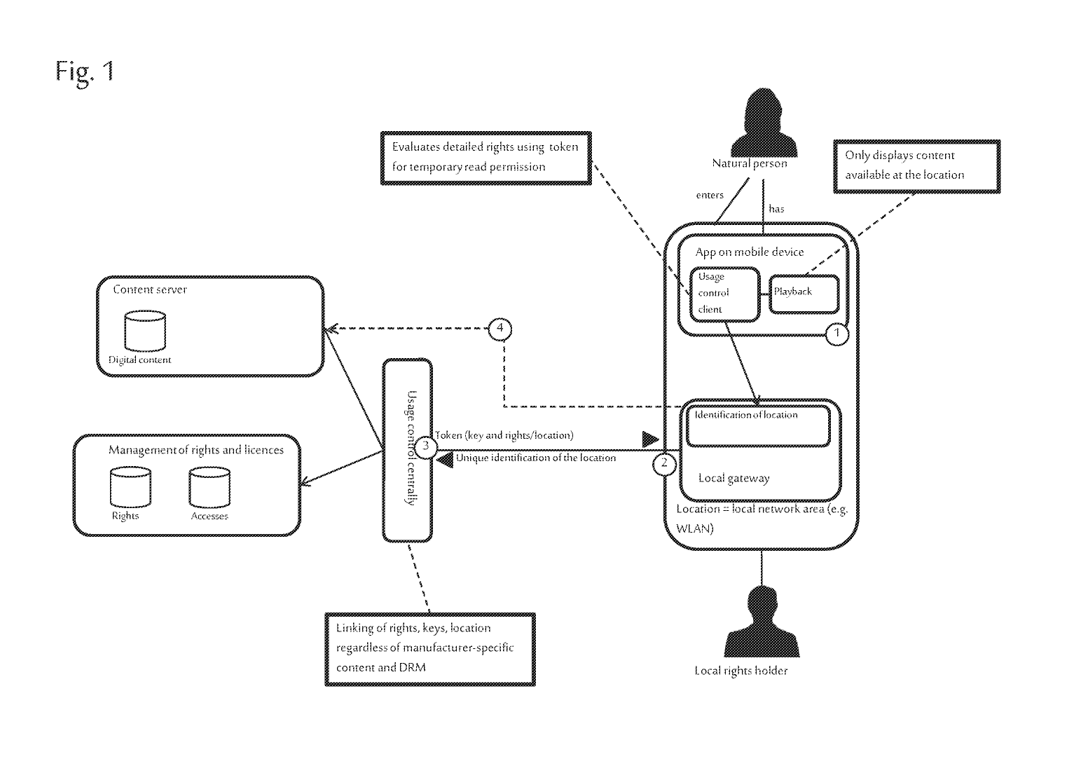

FIG. 1 shows the possible sequence of the method. The following steps must be followed.

1. A potential customer, as a natural person, enters the “virtual reading room”/network segment with his device on which the application is executed as a web app and is dynamically assigned a local network address.
2. As soon as the local network address has been assigned, the app transmits a usage request to the central usage control system. The address for the central usage control system may also be obtained from the DHCP information. Local access control is necessary since the usage rights of the protected content are held via the local rights holder. To prevent misuse, other protective mechanisms may be used if necessary to secure communication with the central usage control system via the local gateway (e.g. authentication techniques such as HMAC, RFC 2104). The central usage control system determines rights and accesses for the location's physical access to the content server and generates a location-specific token which is transmitted to the app.
3. Only with the token does the mobile receive temporary read permission. The app ensures that on expiry of the read right (usually after leaving the local network), the token expires and the local usage control system prevents access to the content.

The app also provides an overview of the content, in this case displaying, in categories and lists, for example, different fields and types of content which the user can then select via a menu structure.

The distribution of the components illustrated in the diagrams represents one of the possible variants in each case. Compliance with the digital rights requires interaction between the reading application (either on the client or as a web application) and the central usage control system which controls the relationship between the rights holder at the location, the uniquely identified location and access to the multimedia content assured according to the contractual arrangements. Logically, this requires the following components:

Reading app: Either on the mobile terminal as a thick client or as a web application. The interaction with the central usage control system must be appropriately safeguarded such that it is possible to ensure compliance with the digital rights

Central usage control: The central usage control system maps the identifiers of the locations to the relevant accesses by the rights holders (authentication), evaluates the rights to the content (authorisation) and returns a corresponding token to the client for access to the content. Access may take place directly from the client or via the gateway depending on the non-functional circumstances. For protection, popular encoding mechanisms such as SSL are used in synchronous or asynchronous processes.

Accesses: The accesses are usually managed via a directory service as part of identity management. As different types of content are used, different types of additions also have to be managed accordingly.

Gateway: The technical component which ensures the assignment of a location-specific ID. In this case, the ID can be assembled arbitrarily (e.g. a network area unique to the location or an identifier which is uniquely assigned by the network provider, such as a location ID or service ID). This ID identifying the local network is communicated to the client on request in the response/answer and is mapped by the central usage control system to the actual rights holder at the location.

Content server/digital content: The content is made available by the content supplier. The central usage control system ensures proper access according to the contractual and technical conditions in conjunction with the content supplier. Access takes place either to appropriately preprocessed content directly in a repository or to the content via interface technology.

Location: Basically all locally limited network areas which can be uniquely localised. The following network technologies are available according to the current state of the art:
DSL
Any localisable WiFi network area
Hotspot
Mobile cells, particularly uniquely geographically limitable picocells or femtocells
Geocaching
Bluetooth
NFC

The usage control system at the location may be implemented either as a web solution with the core functionality in the gateway or as an app (Thick Client) with the core functionality in the app. In each case, distribution of the components of the location-specific usage control system (e.g. via App Store or gateway as appliance) is within the platform provider's area of responsibility and forms a self-contained system. One of the possible distributions is illustrated in the diagram.

In terms of content, the token essentially contains the information of a SAML assertion (security assertion markup language), a standard for exchanging authentication and authorisation information, for example see appendix, reference to the standard at the website:

oasis-open.org/committees/tc_home.php?wg_abbrev=security.

Since, in the sense of a DRM, as a service provider we should offer all components for usage control, it is possible to work internally with a symmetrical signature by using a shared secret. However, if the components are located with different providers, then it is also possible to use a different method.

Logically, here this means a tie to the gateway. Technically, the gateway may also be outside the control of the usage control system depending on the use scenario.

Only the central usage control system permits the actual control of access to the content. The gateway is basically nothing more than a local “entrance gate” for the mobile device. However, the “location” must be technically identified by the network. The gateway supplies the app with the so-called “location ID”. Determination of the ID must be protected. The app only receives the token from the central usage control system if it has a secured location ID. Thus in this case, the gateway logically refers to a network solution which ensures that localisation of the mobile end terminal is taking place and the location can be clearly identified.

Only the central usage control system has knowledge of the rights holders assigned to the locations and it identifies the content accordingly.

This is formulated generically here since we also want to use other network technologies apart from WLAN (e.g. picocells, geocaching, Bluetooth, NFC—see above). That is to say, the logic of the mechanism remains identical everywhere, it is only the specific technical implementation that may vary.

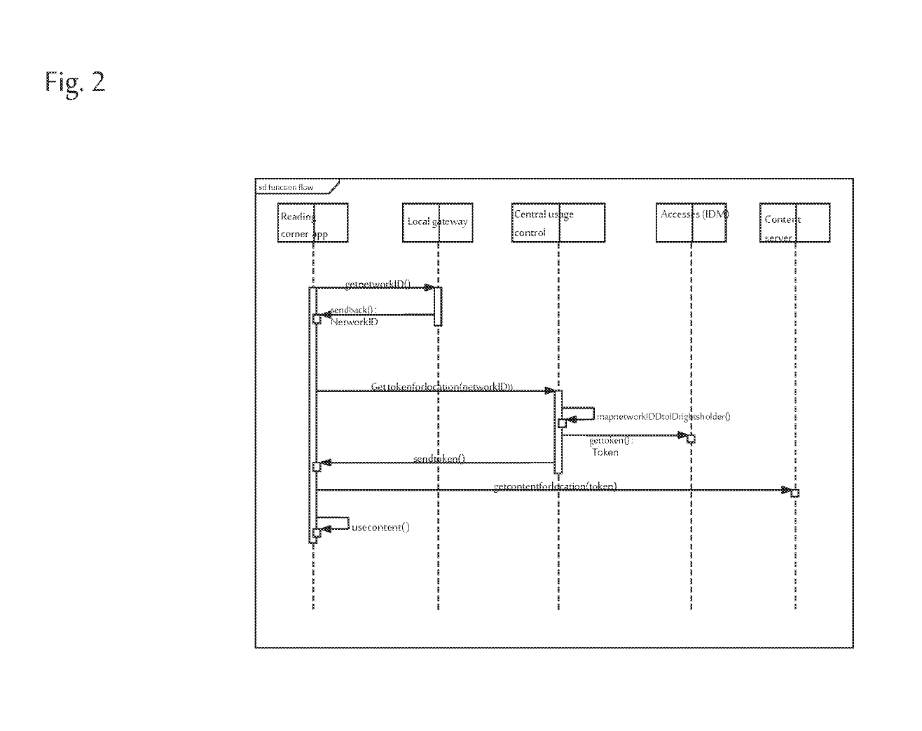

The app only shows the content available at the location (metaphor “local bookshelf”) providing that it receives a valid token and ensures that no further access is possible after leaving the location (expiry of the read permission). FIG. 2 shows the sequential flow using the logical components described above:
Once the user has entered the local network area with his mobile device, the app requests a unique identifier for the location on the gateway.
In the next step, the app transmits the network ID to the central usage control system via an encrypted connection.
The central usage control system identifies the ID of the rights holder at the location and queries the access rights to protected electronic content at the IDM. The temporary token is transmitted back to the app.
   With the temporary token, the app receives access to the content available at the location. It depends on the network conditions whether the app receives direct access to the content server/servers. In practice, various protective mechanisms are conceivable depending on the need for protection.

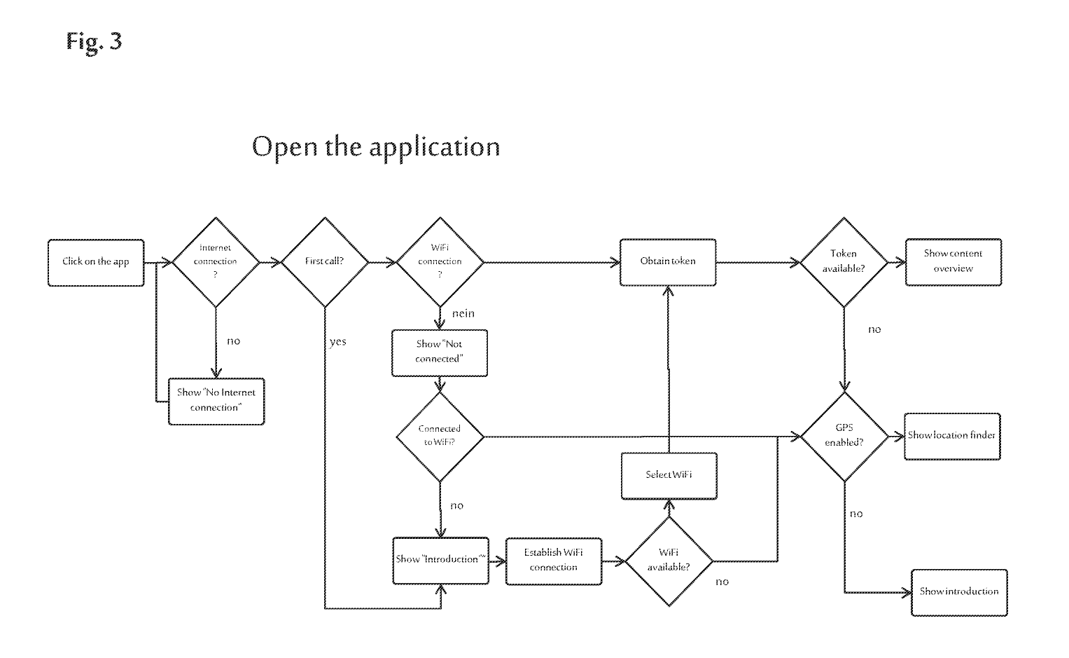

The diagrams in FIG. 3-FIG. 5 show how network technology can be used within an app which provides electronic books, newspapers or audiobooks in a stationary manner. FIG. 3 shows the following: After opening the app, the user either

a) Has content activated for this location displayed immediately and without further authorisation provided that the network used is authorised by the method described in FIG. 2, and described here as the “obtain token” method, to access content (“show content overview”).

b) Has a location finder displayed which illustrates which content is available at which locations.

c) Has an introduction to how to use the application if he is opening the application for the first time.

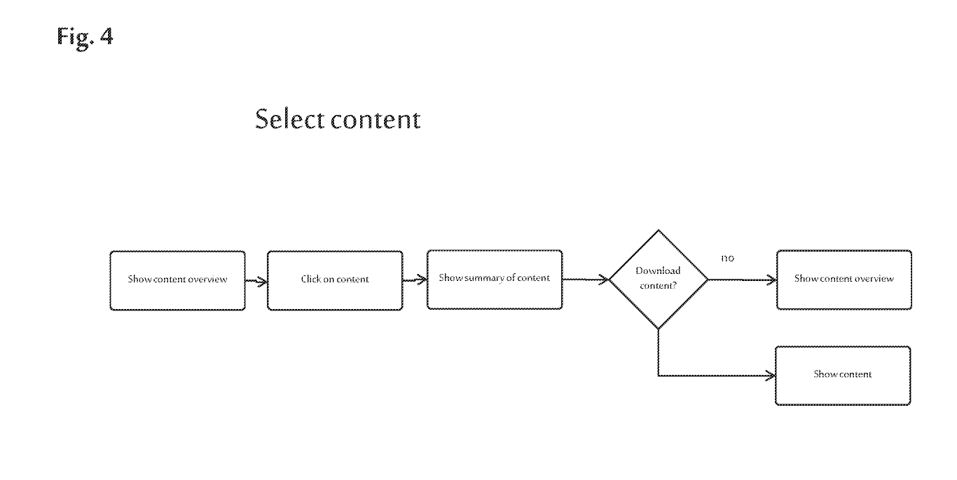

FIG. 4 shows that the user can view and use the content in full in the event of authorisation.

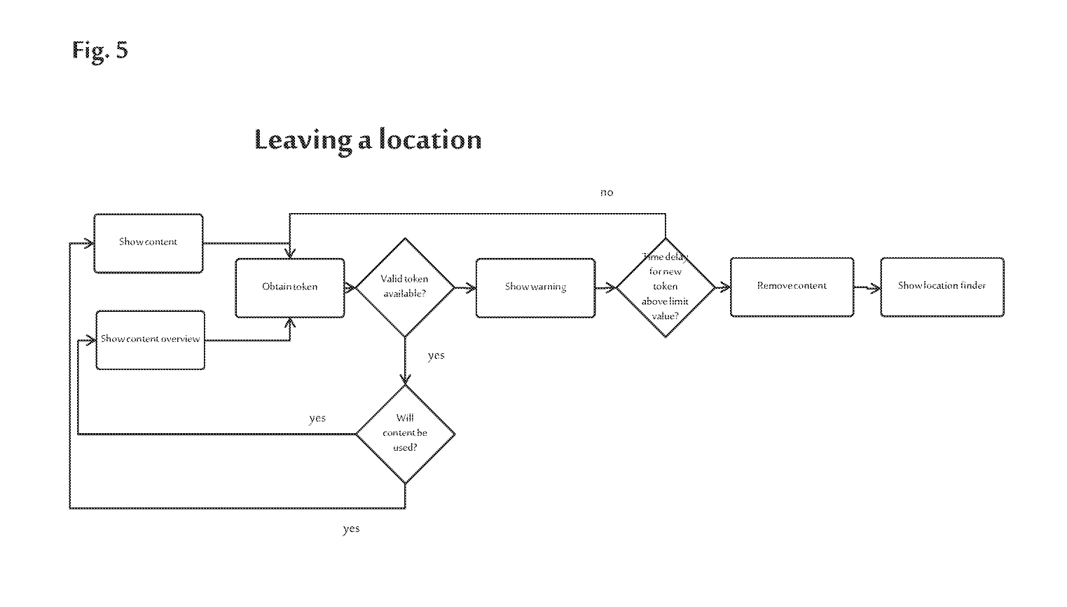

In the background (FIG. 5), the app regularly verifies whether the authorisation is still in place by checking the validity of the token. The content can continue to be used if the token is still valid. A warning message appears if the token is no longer valid. Simultaneously, the time without valid token is added up until a specified limit value is reached. If the time without valid token is above the limit value (“time delay without valid token above limit value?), the content is deleted from the cache (“remove content”). The location finder appears again.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for controlling access to digital data in a network comprising a mobile terminal having a network interface, a geographically limited network segment that provides a network solution which ensures that the localization of the mobile terminal takes place in the network segment and an identification of the network segment can be carried out, a usage server which controls access to the digital data and ensures a compliance with specific rights, the method comprising the steps:
obtaining a unique identification of the network segment in which the mobile terminal is located;
evaluating the unique identification on a usage server which controls the access to digital data based on the unique identification by transferring an access list to the application, wherein the usage server issues a token which is transferred to the application once the unique identification has been received, wherein the token specifies which digital data the application has access to and under what conditions; and
displaying the digital data on the mobile terminal via the application.

2. The method according to claim 1, wherein the unique identification of the network segment is secured by a signature vis-à-vis the usage server such that misuse of the identification is prevented.

3. The method according to claim 1, wherein the application transmits the token on each renewed access to the digital data, such that the data server which provides the digital data can check using the token whether or not the digital data are to be provided.

4. The method according to claim 1, wherein the application runs on a server to which the mobile terminal has access with a browser, wherein the display takes place merely on the mobile terminal but access to the digital data takes place through the server.

5. The method according to claim 1, wherein the application runs on the mobile terminal and access to the digital data takes place via the application.

6. The method according to claim 1, wherein the digital data, after having been downloaded by the application, are cached in an area secured by the application and/or in a sandbox, wherein access to the secured area is only possible with a valid token.

7. The method according to claim 1, wherein the token loses its validity when the mobile terminal leaves the network segment.

8. The method according to claim 1, wherein the application obtains the identification of the network segment from the local network segment with the help of a gateway, which manages the access to the network segment and the identification of the network, by contacting the gateway.

9. The method according to claim 1, wherein the digital data can also be stored directly in the local network of the location, under the condition that the location itself can ensure compliance with the digital access rights and at the same time can independently perform secure communication with the client.

10. A system comprising a mobile terminal and an access server and a geographically limited network segment, configured to control the steps of the method according to claim 1.
